(19) United States
(12) Patent Application Publication
(10) Pub. No.: US 2003/0211627 A1
(43) Pub. Date: Nov. 13, 2003

(54) Method and apparatus for managing a fertility kit

(75) Inventors: Denise Y. Koesterman, Cincinnati, OH (US); Brian F. Berg, Kettering, OH (US)

Correspondence Address: c/o Dinsmore & Shohl LLP, 1900 Chemed Center, 255 East Fifth Street, Cincinnati, OH, 45202, US

(73) Assignee: BioPartners in Care, Inc.

(21) Appl. No.: 10/448,925

(22) Filed: May 29, 2003

Related U.S. Application Data
(62) Division of application No. 09/618,368, filed on Jul. 18, 2000.
(60) Provisional application No. 60/156,179, filed on Sep. 26, 1999.

(51) Int. Cl. G01N 21/00

(52) U.S. Cl. 436/164

(57) ABSTRACT

A method, management system and kit of parts comprising an open base having a lid hingably secured to the base and having therein a fitted insert comprising a plurality of compartments for receiving and maintaining all medications, devices for administering medications and also for providing a medical waste disposal system for needles and syringes therein. The plurality of compartments are individually sized and arranged for receiving the proper amounts of medications and ancillary devices for application of medication and said compartments are arranged to comply with the order of need. The lid has permanently attached thereto on the inside, the Doctor's prescription orders and instructions directing the application of the medications and the use of the ancillary devices contained in the base eliminating confusion on the part of the patient and to assure proper use by the patient.

The combination of the Doctor's prescription orders and instructions in close proximity to the medications and ancillary devices arranged in an orderly manner allows for each of selection and use as required by the user. The method, management system and kit of parts is utilized primarily as a fertility kit, but can be used for other numerous medication application plans.

This application claims priority from U.S. Provisional Patent Application Serial No. 60/156,179 filed Sep. 26, 1999, the disclosure of which is incorporated herein by reference herein.

### BACKGROUND OF THE INVENTION

1. Field of the Invention

This invention relates to the provision of prescription medications and ancillary products needed for a fertility cycle, and more particularly, to a method and apparatus for managing prescription medication and ancillary products in order to effectively control and administer the prescription medications and ancillary products needed for a fertility cycle.

2. Description of Related Art

In the medical industry, generally, and specifically in the specialized area of fertility enhancement it is common for doctors to prescribe certain medications and procedures to be administered by the doctor, nurses or primarily the individual patient.

A problem with such procedures is the proper and timely administration of medications and using the proper procedures and correct ancillary devices in a timely and proper manner. A further problem with such procedures is to adequately keep tract of such medications and to instantly identify and locate the medications and devices required for the appropriate and timely administration of medication.

In the past a patient undergoing fertility treatment after presentation of a doctor's prescription to a pharmacist would receive a quantity of various medications and ancillary devices, i.e., different sizes and types of hypodermic needles, syringes and the like with little or no explanation of proper use, or medication/device matching. This procedure often resulted in misapplication of medications, improper timeliness of application and failure of the procedure because of the confusion experienced by the patient.

Current practice relating to said maintenance, control and administration of fertility medication has been difficult and cumbersome and no real system has been in place to assure the adequate and timely replenishment of certain medications and devices which may be required.

Accordingly, a kit of parts for all required medications, devices and instructions organized effectively in a manner that the patient would not be confused was needed allowing the patient to easily, correctly and timely maintain a given prescription schedule easily and without error, and using the appropriate device and medication combination resulting in a higher frequency of successful fertilizations.

### SUMMARY OF THE INVENTION

Accordingly, a primary object of the invention is to provide a method and management system which will permit a doctor, nurse and/or primarily the patient to maintain all medications, devices and instructions for application of medications in an easy and timely method.

Another object of the present invention is to provide a kit with a plurality of compartments each suitable for receiving at least 1 item of medication or ancillary device required for application of the medications said compartments arranged in a predetermined order. Said order following the order of medication application.

An additional object of the invention is to provide a means for controlling the individualized compartments and maintaining the medications and ancillary devices therein.

Yet another object of the present invention is to provide the user with a medical waste disposal system for needles and syringes which is part of the kit of parts of the present invention, but maintained separate and safely apart from the unused medications and ancillary devices.

A further object of the present invention is to provide a permanent, easily assessable location for all physician instructions and orders.

Still another object of the present invention is to provide a portable parts kit which enables the user to have all medications and ancillary devices available when needed.

Yet another object of the present invention is to provide a kit of parts including everything needed for a full cycle of infertility treatment which is user friendly and contains everything needed in one organized location.

A final object of the present invention is to provide a method and apparatus which is simple in design, easy to use and which is ecologically safe.

These advantages and others will become more apparent in connection with the following drawing and descriptions.

### BRIEF DESCRIPTION OF THE DRAWING

FIG. 1 is a perspective view of the fertility kit encapsulation device according to one embodiment of the invention;

FIG. 2 is a perspective view of the fertility kit showing the various compartments for receiving and holding required medication and ancillary devices according to one embodiment of the invention.

FIG. 3 is a perspective view of the fertility kit showing medications and ancillary devices placed in receiving compartments and showing the doctor's prescriptions, orders and procedures to be followed, placed on the inside of the lid.

### DETAILED DESCRIPTION OF THE INVENTION

Referring now to the drawing, wherein like parts will have like identification numbers, the invention will be described as follows.

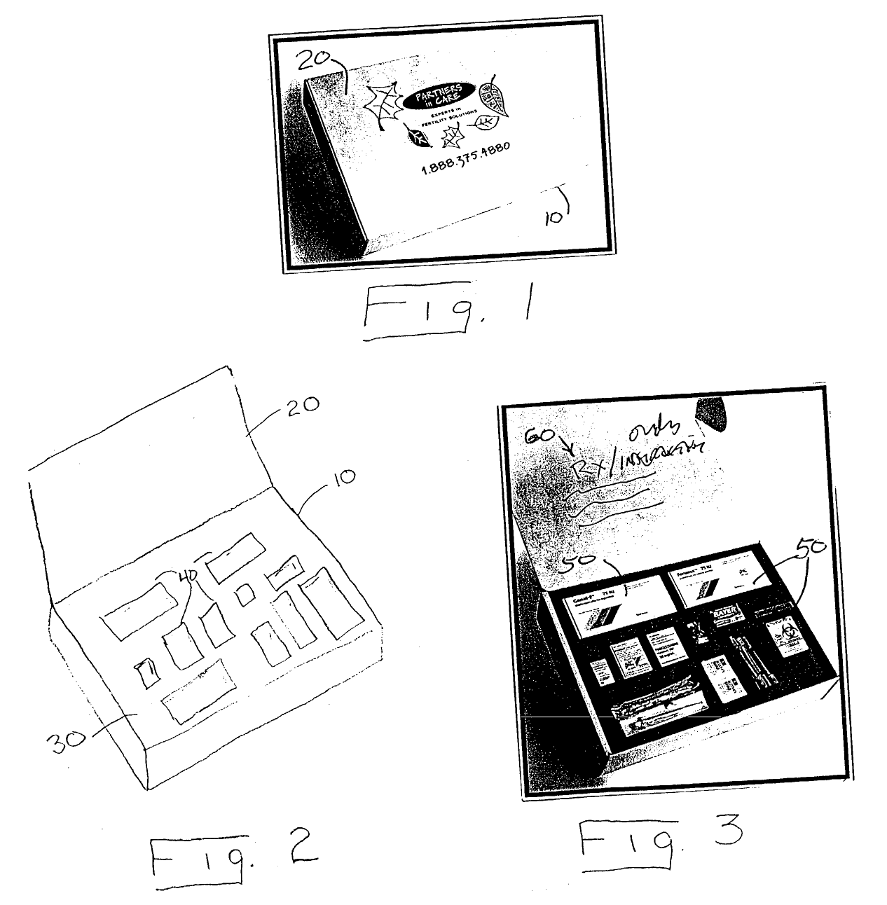

FIG. 1 shows base 10 with hingably attached lid 20 in the closed position. Said base 10 and lid 20 conveniently form a box of any desired size or shape. In the preferred embodiment of the current invention, said box is cardboard but may be of any suitable material.

FIG. 2 shows base 10 with lid 20 in the open position. An insert 30 is further shown with a series of compartments 40 therein. Insert 30 is preferred to be a foam rubber material which can be easily cut and trimmed to a size convenient to fit base 10 and to accept for secure holding the medications and ancillary devices required for use. One skilled in the art will be knowledgeable of other insert material that may be acceptable and which falls within the scope of the present invention.

FIG. 3 shows the placement of medications and ancillary devices 50 within compartments 40 of insert 30 within base 10.

FIG. 3 further shows the placement of the Doctor's prescription, orders and instructions 60 on the inside of lid 20 directly above the medications and ancillary devices 50. It is to be understood that the general order of the medication and ancillary devices are placed in standard order, left to right, top to bottom, as required by the Doctor's prescription, orders or instructions 60 to allow ease of application by the Doctor, Nurse or patient and finally to provide an ecological means of disposing of dangerous medications or devices.

The method, management system, and kit of parts of the present invention permits the user to follow the Doctor's prescription, orders and instructions accurately and to sequentially follow and select the needed medication or ancillary devices needed with ease and eliminating the possibility of error. Having the prescription, orders and instructions together with the medication and ancillary devices decreases and virtually eliminates the likelihood of confusion and/or patient error. The management system also signals when it is time or near time for the user to request a prescription refill.

Although the present invention was originally designed to provide medications, instructions and ancillary devices for fertility patients, it shall be obvious to one skilled in the art that the present invention can be applied to a number of medical situations requiring various courses of treatment. Thus, while the invention has been described with reference to a specific embodiment, the description is merely illustrative, and it is not to be construed as limiting the scope of the invention. Various other modifications and changes may occur to those skilled in the art without departing from the true spirit and scope of the invention. Accordingly this invention is intended to embrace all alternatives, modifications, and variations that fall within the spirit and broad scope of the attached claims.

What is claimed is:

1. A method of managing medications and ancillary devices comprising:
providing a container for receiving one or more medications and one or more ancillary devices; and
organizing within the container each of the medications and each of the ancillary devices.

2. The method of claim 1, further comprising:
providing a lid to the container which when in a closed position secures the medications and the ancillary devices.

3. The method of claim 2, further comprising providing a receptacle to receive medical data on an inside surface of the lid.

4. The method of claim 1, further comprising:
receiving medical data which is displayed within the container with the medications and the ancillary devices.

5. The method of claim 1, wherein the container is a cardboard box.

6. The method of claim 1, wherein the container includes an insert operative to receive the medications and the ancillary devices.

7. The method of claim 6, wherein the insert includes one or more recesses, each recess operative to receive one or more of the medications or one or more of the ancillary devices.

8. The method of claim 6, wherein the insert is foam material.

9. A medication dispensing device, comprising:
a container having a base; and
an insert with one or more compartments operative to receive one or more medications and one or more ancillary devices, the insert affixed within the base.

10. The device of claim 9, further comprising:
a lid attached to the container operative to secure the medications and the ancillary devices when in a closed position.

11. The device of claim 10, wherein the lid includes an inside surface operative to receive medical data.

12. The device of claim 9, wherein the container is a cardboard box.

13. The device of claim 9, wherein the insert is foam material.

14. The device of claim 13, wherein the compartments are recesses cut out of the foam material.

15. A method of dispensing medications and ancillary devices comprising:
providing a container for receiving one or more medications and one or more ancillary devices; and
separating the medications and the ancillary devices within the container.

16. The method of claim 15, wherein one ancillary device is a medical waste disposal receptacle operative to receive medical waste safely and operative to permit safe disposal of the medical waste.

17. The method of claim 15, further comprising:
receiving medical data within the container.

18. The method of claim 15, further comprising:
securing the medications and the ancillary devices within the container by cutting one or more recesses into the container operative to house the medications and the ancillary devices.

19. The method of claim 15, further comprising:
securing the medications and the ancillary devices within an insert affixed within the container.

20. The method of claim 19 wherein the container is a cardboard box and the insert is foam material.
